(19) United States
(12) Patent Application Publication
(10) Pub. No.: US 2005/0116195 A1
(43) Pub. Date: Jun. 2, 2005

(54) Microparticles and methods of making them

(76) Inventors: Shik Chi Tsang, Berkshire (GB); Valerie Caps, Strasbourg (FR)

Correspondence Address: MORGAN LEWIS & BOCKIUS LLP, 1111 PENNSYLVANIA AVENUE NW, WASHINGTON, DC, 20004, US

(21) Appl. No.: 10/500,843

(22) PCT Filed: Jan. 7, 2003
(86) PCT No.: PCT/GB03/00023

(30) Foreign Application Priority Data
Jan. 7, 2002 (GB) 0200260.8

(51) Int. Cl. H01F 1/00; B05D 7/00

(52) U.S. Cl. 252/62.51 R; 252/62.55; 252/62.56; 502/185; 502/182; 427/212

(57) ABSTRACT

Microparticles having a ferromagnetic core encapsulated in a graphitic curved shell containing hetero atoms are prepared by providing a solution containing source material of a ferromagnetic metal, carbon and the hetero atoms e.g. N, forming solidified particles containing source material of the ferromagnetic metal, carbon and the hetero atoms from the solution, and pyrolysing the solidified particles in inert gas so as to form the ferromagnetic core and said encapsulating graphitic coating. Small particles, e.g. of core size 10-150 nm, having good particle size distribution can be obtained, which are useful in catalysis.

### FIELD OF THE INVENTION

The present invention relates to microparticles and in particular to those in the nanoparticle range, and to use of such particles in catalysis, as well as methods of making them.

### BACKGROUND OF THE INVENTION

It has been known to be desirable for some time that solid microparticles having catalytic activity should be preferred for liquid phase catalysis, because on the one hand macro catalysts have clear disadvantages from the point of view of atom efficiency, while soluble catalysts, although theoretically efficient, present great difficulties of separation.

However, the desire for the microparticles to be as small as possible so as to achieve the greatest possible efficiency conflicts in principle with the ease of separating them from the liquid reaction medium, if for example filtration or like methods of separation are attempted.

It is for this reason that there has been interest in magnetically susceptible catalytic microparticles which are dispersible in the liquid reaction medium but which are able to be coagulated under the influence of a magnetic field and thereby readily separated from the medium. They can then be re-dispersed for re-use.

However, the problem then arises that many ferromagnetic materials would react with the reaction mixture; it is therefore necessary to protect the ferromagnetic particles by a coating of some material which is inert to the medium.

In JP-A-02069904, for example, there is disclosed a way of “rust-proofing” a magnetic metal powder by contacting the preformed powder with carbon monoxide, methane or ethane and hydrogen at high temperatures. It is stated that the saturation magnetizations of the magnetic metal films (sic) obtained is not lowered substantially.

Another method which has been used is that of an arc discharge. In IEEE Transactions on Magnetics, 32, No. 5 of September 1996 at page 4511-4513, Jeyadevan et al, after reviewing earlier attempts at encapsulation using arc discharges proposed to coat pre-existing magnetic particles with a surfactant and then treat them in an arc so that the surfactant is reduced or decomposed to a carbon that encapsulates the magnetic particles. The size of the magnetic particles was stated to be an average diameter of 10 nm and the surfactant used was sodium oleate.

Turgut et al J. Appl. Phys. 81 (8) of April 1997 at pages 4039-4041 disclose another arc discharge process and state that in this case many of the particles were only nominally coated or uncoated. The interest in that disclosure concerned the crystalline structure of the magnetic nanocrystals. All of these processes have extremely low yields but also use extremely high temperatures (arc temperatures).

The present inventors believe that these prior art processes produce many different forms of carbon or, if a graphite layer is produced, it has defects and/or has curvature due to the presence of five-membered carbon rings which distort the graphite structure.

Yet another approach is seen in WO-A-99/46782 of Universiteit Utrecht. The inventor is Geus, and this document will be preferred to as “Geus” hereafter. This takes an approach different from that of the rest of the prior art. Ferromagnetic material is deposited on the surface of an alumina support. A graphite coating is then applied and the alumina support is dissolved away leaving particles which are allegedly entirely coated with graphite. The Geus disclosure will be discussed in more detail later.

However, it is clear from the above that all prior processes have been ones which require complex preparative stages before the coated ferromagnetic microparticles were achieved.

### SUMMARY OF THE INVENTION

In contrast, we propose a direct method for the formation of ferromagnetically nucleated graphite-protected microparticles. Furthermore, we find that this method can provide particles within a close size range and with little or no loss in magnetic susceptibility as compared to the pure magnetic material.

After the microparticles have been prepared, catalytically active components such as a noble metal, e.g. palladium metallic clusters, can be supported on the external surface. This results in a highly active carbon-supported catalyst for chemical reactions, for example hydrogenation reactions, in the liquid phase.

The chemically and mechanically robust microparticles (usually in the nanoparticle size range) are shown to disperse well in aqueous or organic solvent and form a stable dispersion and exhibit an excellent and consistent mass transfer so as to sustain a high catalytic rate of reaction.

We find that the coating has very high coherence so that the core is not exposed to the reagent, there is high yield and, as already mentioned, there is a high degree of uniformity of size.

The invention in one aspect therefore provides a method of forming microparticles with a ferromagnetic core encapsulated in a graphitic shell containing hetero atoms, which includes the steps of providing a solution containing source material of a ferromagnetic metal, carbon and hetero atoms, forming solidified particles containing source material of the ferromagnetic metal, carbon and the hetero atoms from said solution, and pyrolysing said solidified particles in inert gas so as to form said ferromagnetic core and said encapsulating graphitic coating containing hetero atoms.

In a second aspect the invention provides microparticles having a ferromagnetic core encapsulated by a graphitic curved shell containing hetero atoms.

The process typically involves the solidification of a solution, e.g. droplets of the solution, containing soluble salt(s) or complex(es) of the ferromagnetic element(s) or alloy(s) and decomposable sources of carbon and of a hetero atom such as nitrogen, and pyrolysis of the solids to form a graphitic/hetero encapsulating shell around a ferromagnetic core. The source of carbon and of the hetero atom is preferably the salt or complex itself/themselves. For example cyanides, isocyanides, cyanates or isocyanates, especially as ligands, are decomposable in the pyrolysis to yield a graphitic shell including nitrogen atoms.

It is believed that the presence of the metal or metals, particularly Fe, Co, Ni or Pd, catalyses the formation of the graphitic shell (which is usually multi-layer). Suitable metals for the core are for example, Fe, Ni, Ca, Zn, Cu, Mn, Mg, Co, Pd, Pt, Ti, Mo and V and at least one metal selected must be ferromagnetic. Use of two or more metals is preferred. One metal may be present in the solution in or as a cationic species, the other in an anionic species, such as a complex anion. Suitable counterions for these species are typically also present.

The pyrolysis is performed in inert gas, such as N₂ or Ar. An inert gas is one which does not chemically react with the particles at the pyrolysis conditions. The pyrolysis temperature must be sufficient to form the core and the graphite coating or shell, preferably so that the shell has a graphitic structure only. The phase or phases formed in the core in the pyrolysis depend on the pyrolysis treatment and also on the metal or metals present. In some cases elemental metal or alloy phase cores are formed, e.g. Fe, Fe—Ni, Fe—Co, Co—Pt, Co—Ni whereas in other cases mixed phases are formed which may be elemental metals (e.g. Fe and Cu phases) or carbide. A carbide only core, such as Fe₃C, or a mixture of carbides, e.g. carbides of Fe and Mn, Fe and Zn, Fe and Ca, may be formed.

N is preferred as the hetero atom. Other hetero atoms which may be used are, for example, B, P, S, or O.

The formation of the solidified particles may be achieved by first dividing the solution into droplets, e.g. by forming a spray. Solidification of the droplets may be the first phase of pyrolysis; or it may be a precipitation occurring as a result of contact with a precipitant such as, for example, ammonia or other alkaline solution. Alternatively chemical precipitation of particles from the solution may be performed in bulk, e.g. by changing the pH of the solution by addition of alkali, and separation of the particles. Use of droplets improves the size distribution of the particles, i.e. allows controlled size and narrow size distribution.

Typically the formation, e.g. precipitation, of the particles from the solution in the process of the invention is performed in the absence of other solid particles, i.e. heterogeneous particles not dissolved in the solution (such as nucleating or seeding particles).

The solution may further contain a diluent source or precursor forming on pyrolysis a diluent for the microparticles, e.g. an amorphous matrix. Decomposable diluent sources include polyvinyl alcohol (PVA), preferably partially hydrolysed, polyvinyl pyrrolidone (PVP) or other polymers. Inorganic sources, especially of calcium, may also form diluent material outside the microparticles. The sources may act to dilute the ferromagnetic and graphitic source species to prevent wasteful agglomeration of microparticles via their graphitic layers. The amorphous mass may contain individual microparticles distributed through it.

To prepare catalytically-active particles, the carbon surface, either of the microparticles or of a diluent matrix containing them, may be functionalized e.g. by acid treatment, for carrying catalytic functions such as metals. These catalytic functions may be added by conventional procedures.

Particular solution systems may be as follows:

Nickel-iron alloy microparticles can be prepared from iron nitroferricyanide Na₂[Fe(NO) (CN)₅]-nickel nitrate solution. Other systems include Fe/Ca; Fe/Zn, Fe/Cu, Fe/Mn, Fe/Co, Fe/Ni, Fe/Mg, Fe/Pt composites, or their carbides, oxycarbides, oxides and mixed oxides as inner cores within the encapsulation.

Typically, other carbon-coated Fe based alloys or mixed composites cores can be prepared via an aqueous solution of iron cyanide containing precursor, Na₂Fe(CN)₅NO.2H₂O mixed with aqueous solutions of (CH₃COO)₂Co.4H₂O, (CH₃COO)₂Cu.H₂O, (CH₃COO)₂Zn.2H₂O, (CH₃COO)₂Mn.4H₂O, Mg(NO₃)₂.6H₂O, Ca(NO₃)₂.4H₂O, PtCl₄(NH₄)₂ (in a 1:1 Fe:M molar ratio), respectively.

In many of these systems there is variability in the metal/carbon atomic content of the salt or complex. Adjustment of this ratio affords a means of adjusting the average thickness (number of layers) of encapsulation graphite.

An additional step of treatment of the particles with acid after pyrolysis is beneficial. Firstly it removes metal impurity, i.e. metal which has not been fully encapsulated in graphite and which may affect catalytic properties. Secondly, the acid treatment can add functionality to the graphite surface. Alkali treatment, with or without oxidising agent, e.g. bleach, may be employed to add functional groups.

The microparticles are characterized by the presence of hetero atoms (usually nitrogen, but possibly B, P, O, etc.) in a graphitic carbon shell surrounding and encapsulating the ferromagnetic core. Preferably the hetero atom content in the graphitic shell is at least 1 atom %, a suitable maximum being 10 atom %. Typically the content is 2-7 atom %. Otherwise, apart from trace impurities, the shell is carbon. These hetero atoms provide curvature, analogous to that of fullerene, so that a more complete enclosure of the core is achieved without the faults or fractures of a purely graphitic structure. It is believed that the incorporation of the chemically bound hetero atoms into the graphite molecular structure causes this curvature of the graphite layers. Since the graphite layer is normally planar, deviation from planar forms in pure graphite is obtained by defects such as fracture or discontinuities, or possibly by the presence of five-membered carbon rings as mentioned above. By incorporating hetero atoms in sufficient amount to cause curvature, in this invention, a stable high-quality coating or shell with minimal defects is obtained.

The number of carbon layers in the graphite coating may be 1 to 1000, more preferably 1 to 100. A plurality of layers is usually formed. The thickness of each layer is about 0.34 nm.

The cores of the microparticles preferably have an average diameter in the range of 5 to 500 nm, more preferably 10 to 150 nm, most preferably 10 to 50 nm.

The more complete covering afforded by the carbon shell and the regularity of size of the particles are great advantages in the context of liquid-phase catalysed reaction.

With such small magnetic catalyst bodies, the advantages of homogeneous (or colloidal) and heterogeneous catalysis may be combined since, while there is no agglomeration, the catalytic sites per area on the small particle are optimised and very well accessible. Application of external magnetic field leading to agglomeration of these magnetic particles facilitates their separation from product. Apart from catalysis application, other useful applications of such carbon-encapsulated nanometer sized particles may also be expected in several fields of technology.

The invention further consists in use of the microparticles described above in catalysis, for example hydrogenation. For this purpose, the microparticles typically carry catalytically active metal on their surface i.e. on the carbon shell and/or on the amorphous diluent incorporating the microparticles.

### BRIEF INTRODUCTION OF THE DRAWINGS

In the accompanying drawings:

FIG. 1 is a schematic diagram of a nano-size soft magnetic alloy encapsulated in quasi-spherical graphitic shells;

FIGS. 2a and 2b (comparative) are X-ray diffraction patterns for Geus particles before and after acid treatment, respectively;

FIGS. 3 and 4 (comparative) are respectively high (×800,000) and low (×46,000) transmission electron microscope (TEM) micrographs of Geus particles;

FIG. 5 is an X-ray diffraction pattern (XRD) of the particles of Example 2 of the invention after acid treatments;

FIG. 6 is a low-resolution TEM micrograph of a present sample before pyrolysis;

FIG. 7 is a high resolution TEM micrograph of present particles after pyrolysis;

FIG. 8a is an X-ray photo-electron spectroscopic (XPS) record demonstrating the presence of hetero atoms in the shell;

FIG. 8b is an XPS spectrum of the N region of the particles before heating;

FIG. 9 is a vibrating sample magnetometer (VSM) graph of a present sample before acid functionalization;

FIG. 10 is a graph showing the catalytic activity of a present catalytic sample;

FIG. 11 is an XRD spectrum of a second embodiment of particle after pyrolysis;

FIGS. 12 and 13 are a low resolute TEM micrograph of the second embodiment before and after pyrolysis respectively;

FIG. 14 is a high resolution TEM micrograph of the second embodiment after pyrolysis;

FIGS. 15 and 16 are VSM and EDX records respectively of the second embodiment after pyrolysis;

FIGS. 17 and 18 are high- and low-resolution TEM micrographs respectively of particles of a third embodiment;

FIG. 19 shows magnetic responses (VSM) of particles obtained in examples of the invention; and

FIG. 20 shows rates of a hydrogenation reaction catalysed by particles.

### EXAMPLES

### System Example 1 (Comparative)

### Preparation of Carbon Encapsulated Nickel-Iron Nanoparticles on a Solid Support (Alumina) Via Gaseous Methane Decomposition (Geus Method)

We adopted and modified the method of Geus. Alumina-supported nickel-iron alloy particles were prepared by a general controlled deposition-precipitation method as follows: a solution containing nickel compound was prepared by dissolving 2.0 g of nickel (II) nitrate hexahydrate (Ni(NO₃)₂.6H₂O) into 10.0 ml of deionised (DI) water. 4 g of activated alumina were added to the solution and the pH was adjusted to 5. An aqueous solution containing iron compound (2 g of sodium nitroferricyanide (III) dihydrate Na₂[Fe(CN)₅NO.2H₂O] in 10.0 ml DI water was then added to the mixture at a rate of 1 ml/min under vigorous stirring giving in total 1:1 molar ratio of Ni:Fe. The solid material was filtered, extensively washed, dried overnight at 120° C. and calcined at 300° C. in a flowing stream of 30 ml/min air for 3 h. Formation of alloy particles on alumina was conducted by controlled reduction of the solid at 700° C. (with a temperature programmed ramping from room temperature to 700° C. at 6° C./min) under a flow rate of 100 ml/min 20% H₂ in nitrogen for 2 h. Deposition of carbon was then carried out by placing the solid at 700° C. in a stream of 20% methane in nitrogen at a total flow rate of 100 ml/min. After completing the carbon encapsulation the resulting solid was cooled to room temperature in a flow of nitrogen. The alumina support was allowed to dissolve in boiling concentrated HC1 at 120° C. for 15 h. The solid was collected, exhaustively washed and dried.

### Synthesis Example 2

### Preparation of Carbon Encapsulated Nickel-Iron Nanoparticles Directly from Solution (Inventive Method)

Three aqueous solutions (2 g of nickel (II) nitrate hexahydrate (Ni(NO₃)₂.6H₂O) in 10.0 ml of DI water; 1 g of polyvinyl alcohol of MW 31,000 to 50,000 in 100 ml DI water; 2 g of sodium nitroferricyanide (III) dihydrate [Na₂Fe(CN)₅NO.2H₂O] in 10.0 ml DI water) were mixed together. The solution mixture was allowed to pass to the pneumatic sprayer head kept at 20 psi (140 kPa) N₂ gas. A fine mist of this solution mixture was sprayed into the headspace of a jar filled with 0.88 sg (specific gravity) saturated ammonia solution. The fine droplets immediately form solid precipitates when in contact with ammonia (vapour and solution). The solid was then collected, centrifuged, extensively washed in ethanol, dried in air at room temperature and calcined at 900° C. for 10 h with temperature increase at 10° C./min. During calcination N₂ is passed at 100 ml/min. Before the characterization described below, the microparticles produced by the calcination are purified by immersion in dilute HCl for 3 h at room temperature.

### Synthesis Example 3

### Preparation of Carbon Encapsulated Nickel-Iron Nanoparticles Directly from Solution (Inventive Method)

The fine mist particles generated as in Synthesis Example 2 but from a solution lacking PVA were sprayed directly into a hot zone of a furnace at 900° C. with a counter current of N₂ at 15 ml/min. As they enter the zone the droplets solidify and then fuse and calcine as before to yield nanoparticles encapsulated by graphitic/hetero atom layers as before.

### Synthesis Example 4

### Fe/Ca System Leads to Carbon-Encapsulated Fe₃C Nanoparticles (Inventive Method)

The same iron source, Na₂Fe(CN)₅NO.2H₂O, is used as in the previous examples. An aqueous solution of this iron precursor is mixed with an aqueous solution of Ca(NO₃)₂.4H₂O in a 1:1 Fe:Ca molar ratio and treated by the spray precipitation protocol of Example 2. Polyvinyl alcohol is not included.

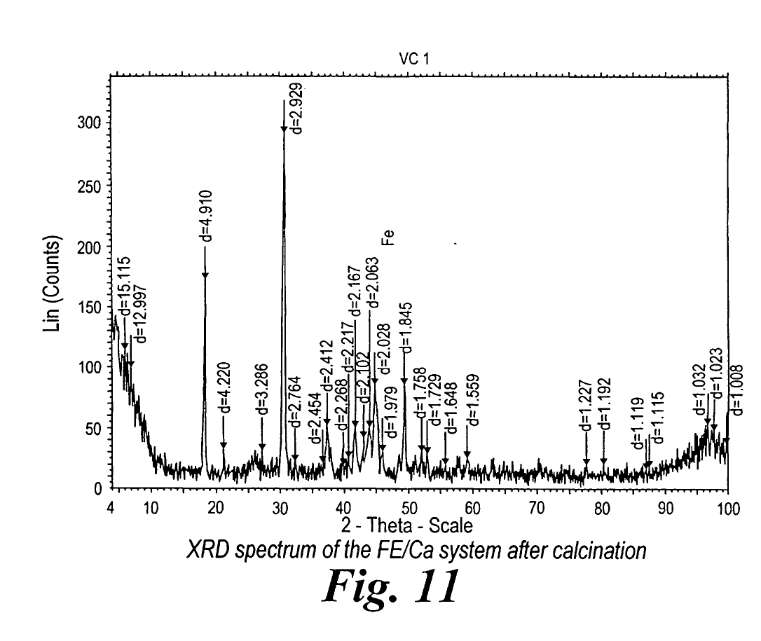

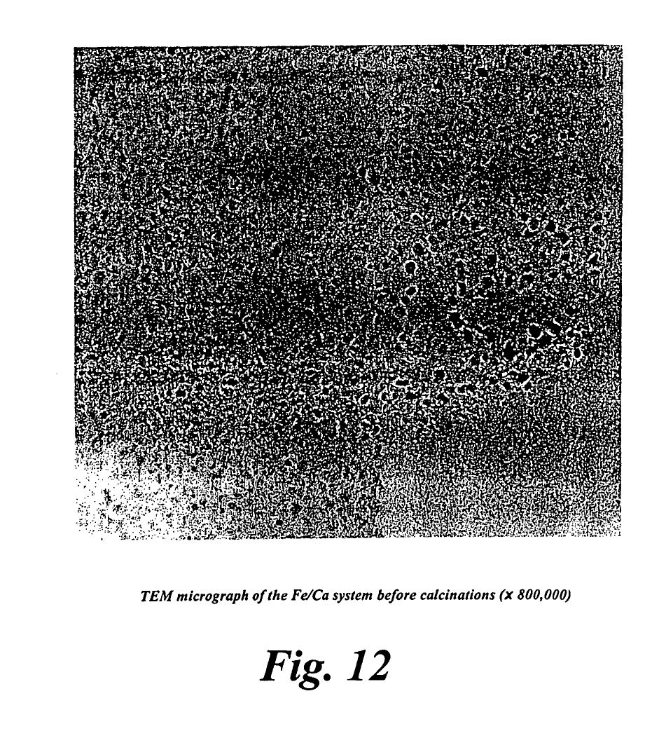

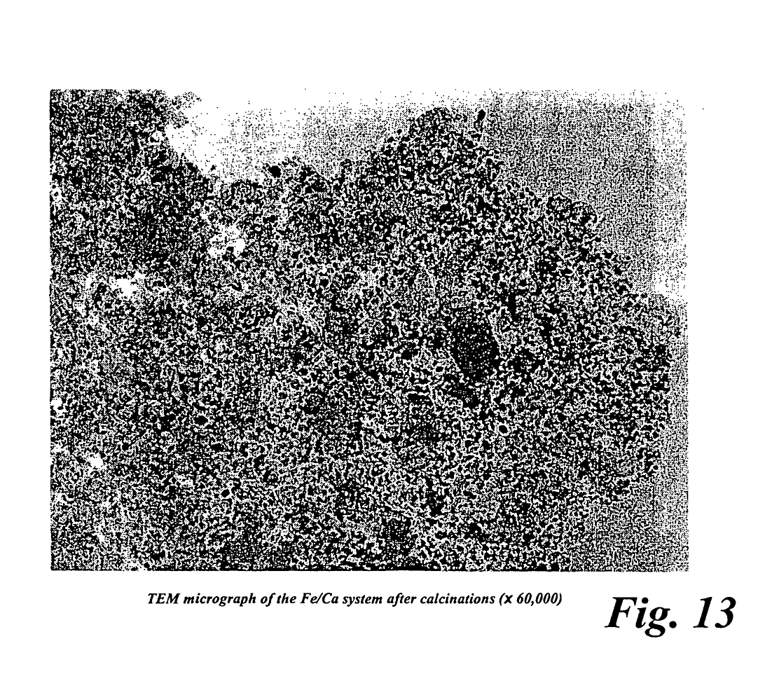

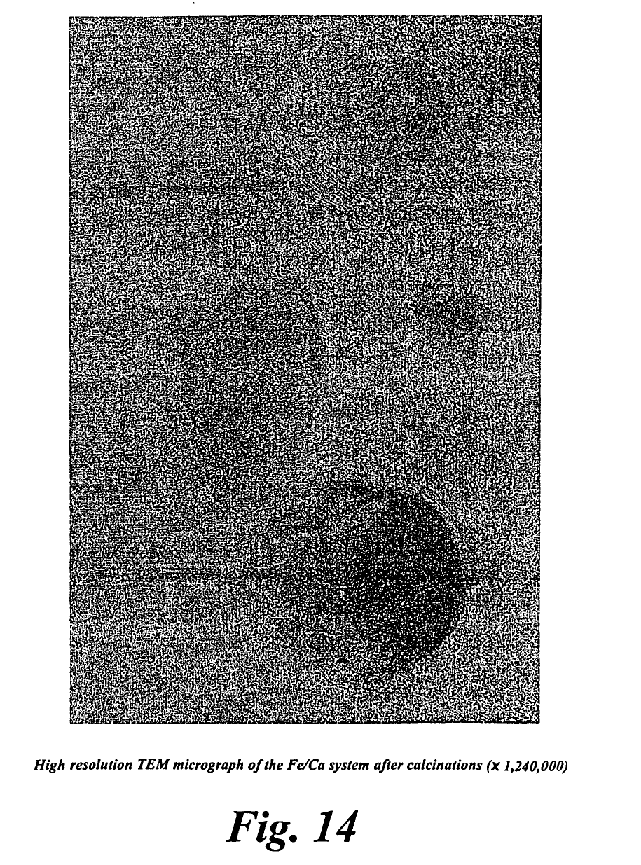

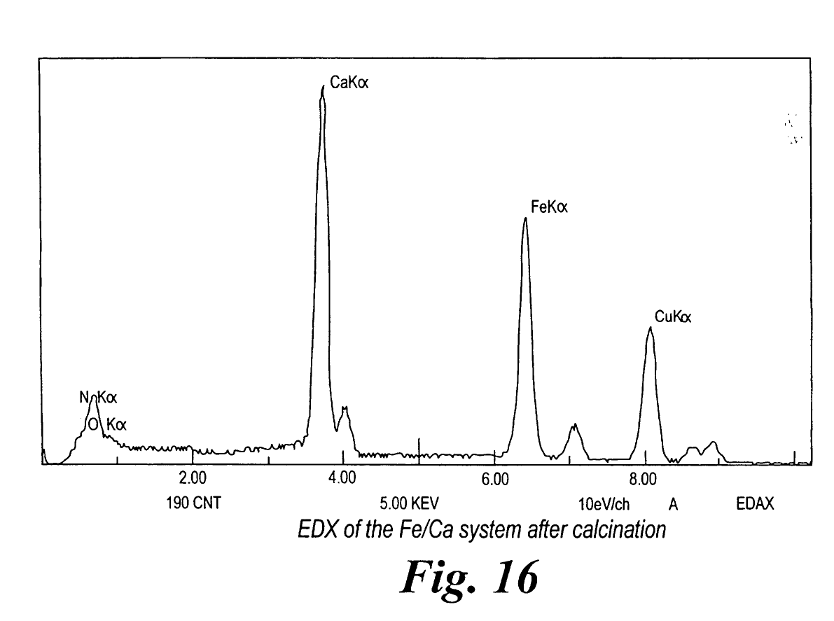

The Fe/Ca system enables the obtaining of a very high concentration of carbon-encapsulated nanoparticles with a very narrow size distribution. The XRD spectrum (FIG. 11) shows that this sample consists of Fe₃C nanoparticles encapsulated in concentric graphitic carbon layers with Ca(OH)₂, CaCO₃ and related Ca-containing species. Energy Dispersive X-ray analysis (EDX) indicates the presence of Ca and iron rich material (FIG. 16). The Cu peak is from the container holding the sample. TEM micrographs of the sample after calcination show that the iron carbide nanoparticles are encapsulated in graphitic carbon (FIGS. 12-14), the amorphous calcium-containing phases forming matrices between the graphitic-coated iron carbide particles (FIG. 13). We attribute this to the fact that calcium would not form a stable alloy with iron (compare Fe—Ni) but its presence with the Fe-based nanoparticles (FIG. 14) protects the composite material from sintering during the heat treatment in N₂, hence providing a very high concentration of carbon coated iron containing nanoparticles with a very homogeneous size. Microanalysis of the product shows that it contains Ca-35.49 wt % and Fe-29.57 wt %. Adding excess acidified water to the final material allows removal of particularly the calcium-containing matrix (63.3 mg Ca and 37.06 mg Fe could be leached out from 200 mg solid in the 50 mL HCl solution), releasing the tiny colloidal graphitic carbon-encapsulated magnetic Fe₃C nanoparticles. These carbon coated particles contain Ca 3.6 wt % and 10.89 wt % Fe.

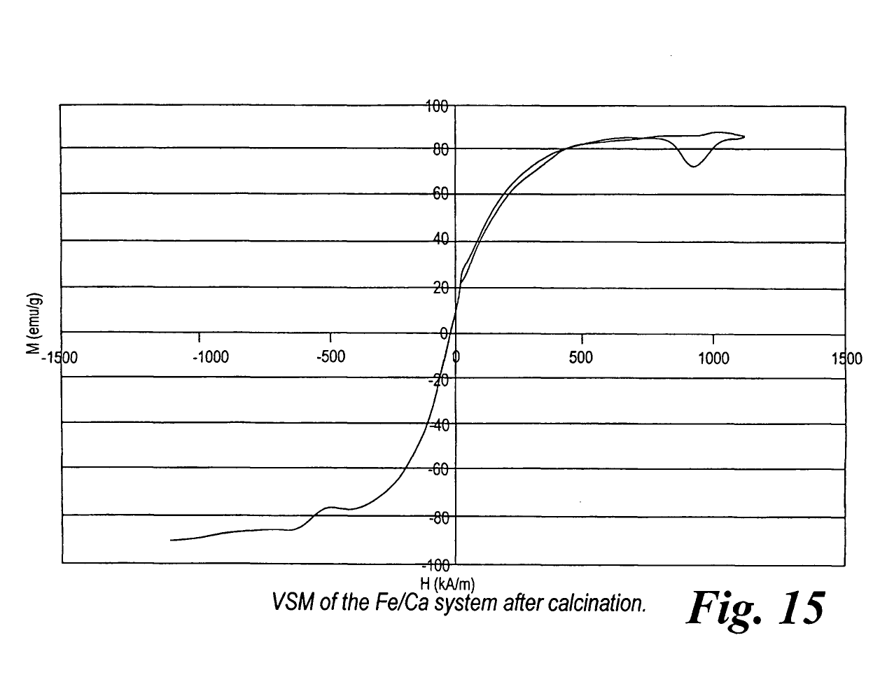

Iron carbides Fe₂C, Fe_{2.2}C, Fe₅C₂ and Fe₃C all are ferromagnetic, displaying a high coercive force. Fe₃C is known to give a high magnetic response but its extreme air sensitivity limits its uses. It is of high interest that this technique can prepare macroscopic quantity of magnetic carbon-encapsulated iron carbide nanoparticles. FIG. 15 shows that our sample displays a saturation magnetization of 90 emu/g. It is apparent that this material is quite air-stable; presumably the graphite coating offers protection against oxidation.

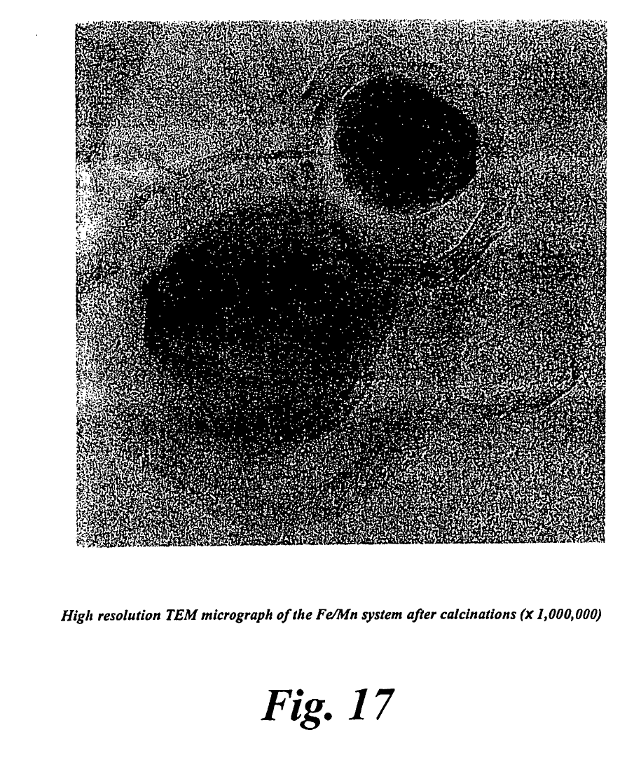

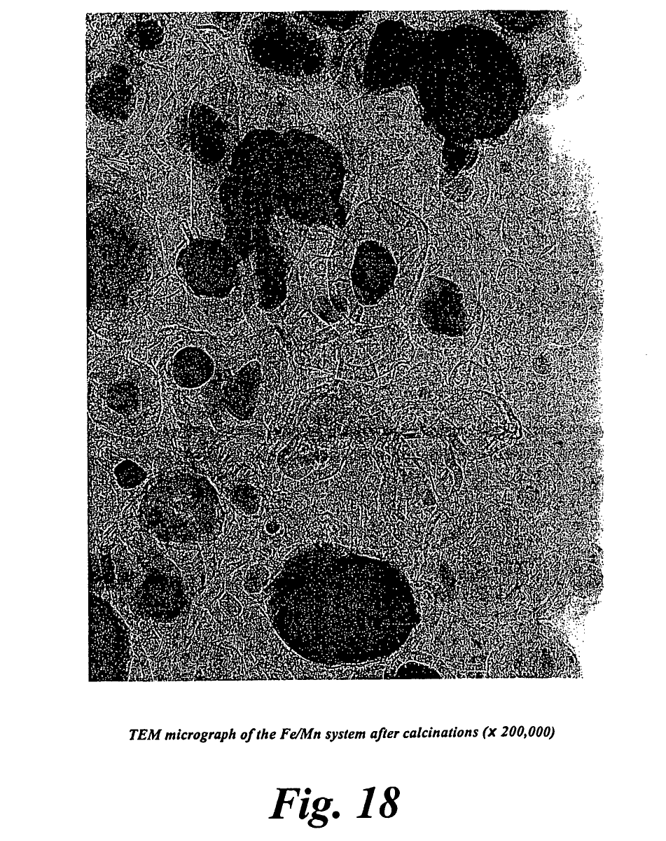

TEM imaging (FIGS. 17,18) clearly shows graphitic encapsulation of other systems such as Fe/Mn indicating the generic nature of the method.

### Synthesis Example 5

### Noble Metal Deposition Onto the Carbon Nano-Materials

The catalyst component (heterogeneous catalyst or homogeneous catalyst species) may be directly deposited onto the external surface of the carbon coated nano-magnet composites. However, it is desirable to functionalise the external carbon surface. Accordingly, the surface of the carbon encapsulated alloy particles prepared by the method of Example 1 on the one hand or Examples 2 or 3 on the other was functionalised with —OH or —COOH groups by immersing them into boiling concentrated HCl (acid treatment) or diluted bleach (NaOCl with and without H₂O₂) solution. For some applications an acid or bleach washing step is advantageous to remove traces of uncoated metal or metal oxide. The surface activated carbon particles were then collected, washed and dried. A wetness impregnation method was then applied in order to deposit 5% Pd onto these carbon based materials (an appropriate amount of Pd (II) acetylacetonate was allowed to dissolve in acetone/water mixture at pH 10 and then stirred with the solid for 3 h at room temperature; the solid was then collected after extensive washing with acetone and air drying at room temperature).

### Example 6

### Catalyst Testing

6.5 ml of nitrobenzene was dissolved into 125.0 ml of isopropanol (IPA) as a solvent (well dispersed) and was placed in a glass beaker inside a 300 ml batch stainless steel Parr reactor. 30 mg of the carbon-based catalyst was then added. The reactor was purged with a nitrogen flow for 5 minutes followed by intermittent purges with pure H₂ at 2000 kPa (20 bar). This ensured that the reactor was actually filled with pure H₂ without trapping any other gases. The reactor was kept at 2000 kPa (20 bar) and heated up to 80° C. with constant stirring. Samples (<1 ml) were collected at different times from the reactor via the internal sampling dip tube without seriously disturbing the on-going reactions. The samples were analyzed by HPLC. For the hydrogenation of nitrobenzene, aniline was the major product observed.

### Example 7

### Material Characterization

In order to determine the formation of Fe—Ni alloy and graphitic carbon structure X-ray powder diffraction (XRD) was carried out. XRD patterns were recorded at room temperature using the Cu Kα radiation (λ=1.54056×10⁻¹⁰ m)

The materials were also examined using a Philip CM20 high-resolution transmission electron microscope (TEM) operating at accelerating voltage of 200 kV. Samples were suspended in isopropanol. A few drops of the suspended solution were put onto a copper grid covered with a holed lacey carbon film prior to examination.

Magnetic measurements were performed using a vibrating sample magnetometer (VSM), which consisted of an electromagnet (maximum applied field of ±1200 kAm⁻¹) with a sample cell holder vibrating between two pole faces. Powder samples were prepared by placing a small amount of wax in the base of a brass sample holder, followed by topping it with approximately 50 mg of the powder sample. The powder was set in place by dripping a small amount of molten wax on top and then plugging with a brass stopper, which was then put into a Perspex outer sheath. The sample was then aligned by placing the holder in boiling water to melt the wax and cooled in an applied field of 2T. The sample was then magnetised to saturation in a pulsed magnetic field (up to 9T) parallel to the direction of measurement. The sample was held at the end of a rod linked to an oscillator, causing the sample to vibrate in a direction perpendicular to the applied field between detection coils positioned on the pole tips of an electromagnet. A current was passed through the coils of the electromagnet producing an applied field that was measured using a Hall probe. Various fields were applied allowing time for the field to stabilise each time, thus eliminating any signals being produced in the coils due to the applied field. the vibration of the sample generated an AC signal from the coils proportional to the magnetisation of the sample. A frequency of 70-80 Hz was used, as there was a minimum of background noise in this range. Hence, the VSM measured the difference in magnetic induction between a region of free space with and without the sample as it vibrated giving a direct measure of the magnetisation M. While the sample is in the magnetic field the magnetic induction was B_{M}=μ₀(H+M)as the sample was moved away. This changes to B₀=μ₀H, which gave the change in magnetic induction ΔB=μ₀M, B—magnetic induction, H—magnetic field, M—magnetisation, μ₀—permeability of free space.

Temperature programmed oxidation was carried out using a purpose-built apparatus. Carbon sample (50 mg) was sandwiched between two silica wool plugs in a quartz reactor tube housed in a temperature controlled tubular furnace. Diluted air (5% O₂) was allowed to flow through the sample at a constant flow rate (2 ml/min). A quadruple mass spectrometer was used to monitor the exit gas (mass fragments) continuously without much delay since the dead volume between the mass spectrometer and the reactor tube was carefully minimised. The sample was ramped at 10° C./min from 150 to 400° C. and then 2° C./min from 400 to 900° C. under the same flow rate. Since different forms of carbons (amorphous, tubular, graphitic, enclosed) react with oxygen at different temperatures (different in chemical reactivity), hence with calibration their differentiation is achieved.

Results of Material Characterization

A: Geus Method—Synthesis Example 1

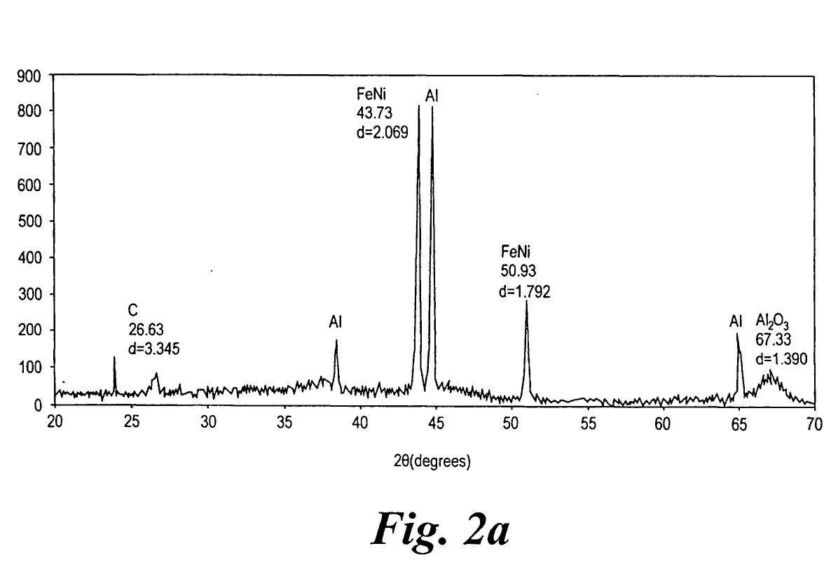

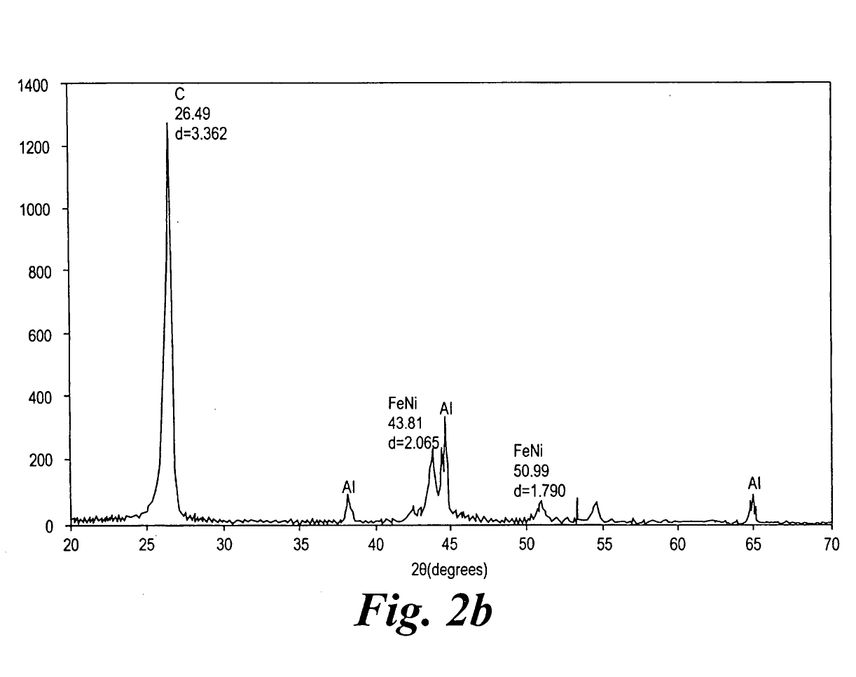

XRD measurement (FIG. 2a) on the calcined alumina-supported cyanide precursors after H₂ reduction and methane treatment as according to Geus show clearly the characteristic peaks of graphitic structure (2θ=26.63°, d=3.345), FeNi (1:1) alloy (2θ=43.73° and 50.93° with d=2.069 and 1.792, respectively) and alumina (2θ=67.33°). No peak is matched to individual metal (for Fe, d=2.027 and 1.433; for Ni, d=2.034 and 1.762) or metal oxide peaks (for Fe₂O₃, d=2.518 and 2.953; for NiO, d=2.088, 2.412, 1.477 and 1.476; for (Ni, Fe) Fe₂O₄, d=2.520, 1.479, 1.610, 2.950 and 2.091) suggesting alloy (FeNi with d=2.080 and 1.800) is favourably formed on the porous alumina support. The calculated average particle size of the alloy after accounting for the instrumental peak broadening is about 36.6 nm.

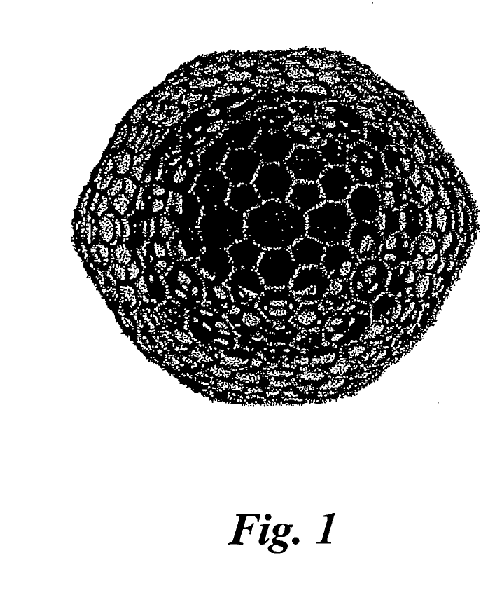

Acid treatment of this material leads to retention of 6.1% wt of acid insoluble material (Geus/methane/850° C.). The XRD measurement (FIG. 1b) clearly indicates that the alumina support is removed (peak at 2θ=67.33° removed) by the acid treatment; however, it also appears to dramatically reduce the alloy intensity relevant to graphitic structure and shifts the average alloy particle size to 16.7 nm.

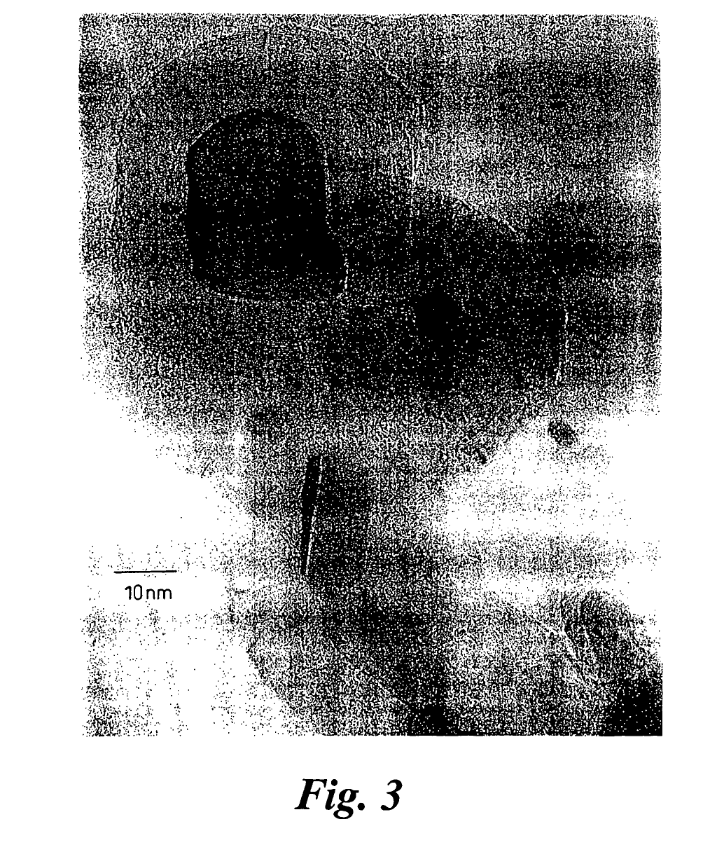

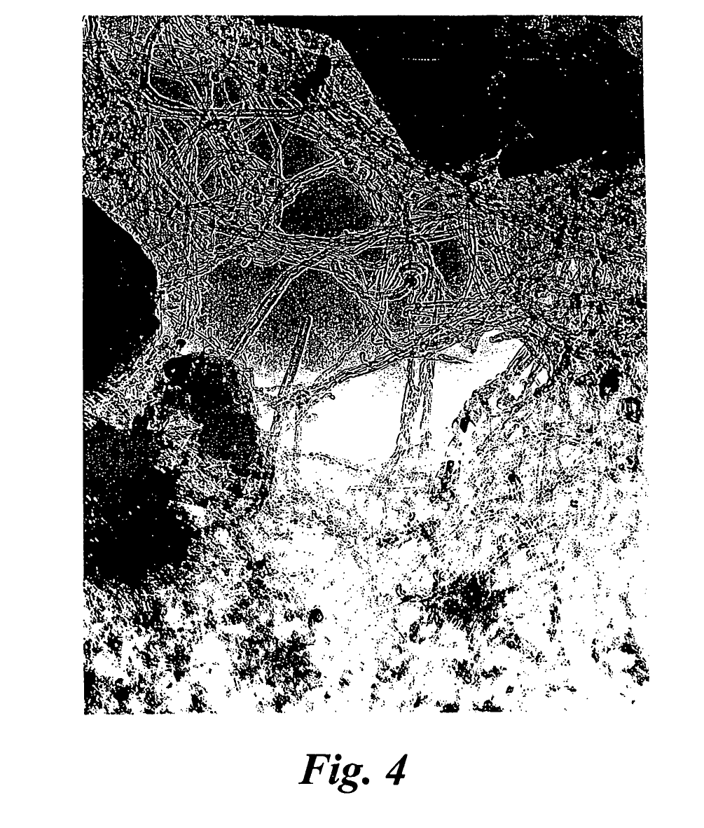

TEM clearly shows that some alloy particles are encapsulated in polygonal graphitic structures (FIGS. 3 and 4); however, their size distribution is extremely broad (10 to 200 nm). Energy Dispersive X-Ray (EDX) analysis confirmed the presence of Fe and Ni. The number of the encapsulated graphitic layers vary from particle to particle and more than 15 layers of carbons are commonly found. Also, there are many other forms of carbon structures (amorphous, graphitic, tubular, whisker, fibres, onions, encapsulated carbons, etc.) observed. After the acid treatment the alumina support and incomplete carbon coated metal/metal oxide are removed. The final product contains mainly carbon structures (tube, amorphous, fibres, onions, etc.) the principal form of which is found to be the tubular carbon. It is noted that there is very small amounts of carbons still containing metallic inner cores present in the final product.

B: Product of Method Embodying the Invention—Synthesis Example 2

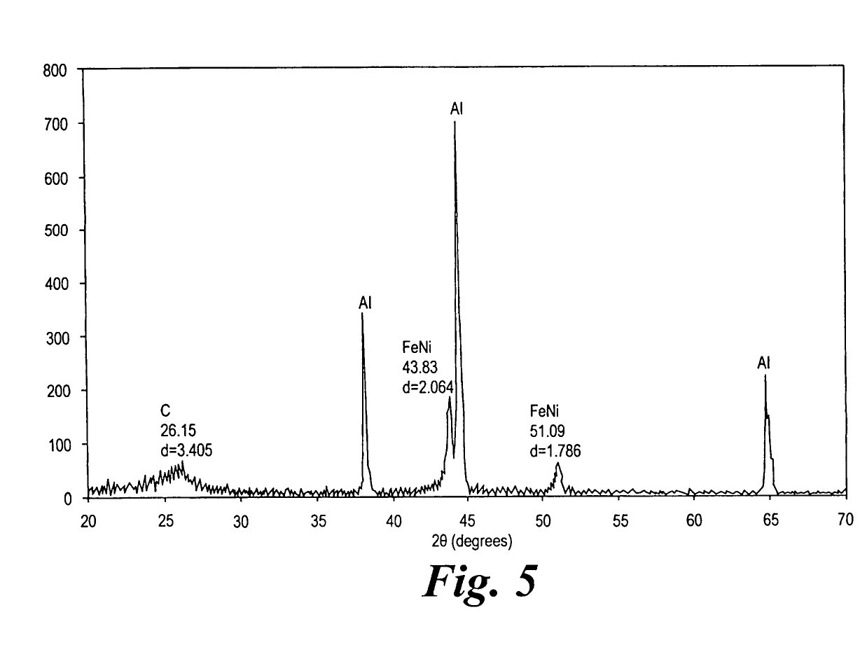

XRD measurement (FIG. 5) clearly indicates the presence of alloy peaks (2θ=43° and 51° with d=2.07 and 1.79, respectively) in a correct intensity ratio. The calculated average particle size is considerably smaller than the material prepared by the Geus method. In order to provide a carbon support to each of these coated alloy nanoparticles soluble polyvinyl alcohol (PVA hydrolysed, MW 31,000 to 50,000) is added to the solution prior to spraying. Polyvinyl alcohol is known to decompose readily at elevated temperatures (ca 120° C.). Hence it is a carbon source for an amorphous matrix. XRD in FIG. 5 shows that the calculated average encapsulated core size is 11.0 nm with the three distinctive Fe:Ni alloy peaks. There is only a very small broad hump near the 2θ of 26° indicating consistently only a few atomic layers (even after pyrolysis of the composite material at 900° C.). 35% wt of insoluble material is retained under identical acid treatment conditions as were employed for the Geus samples.

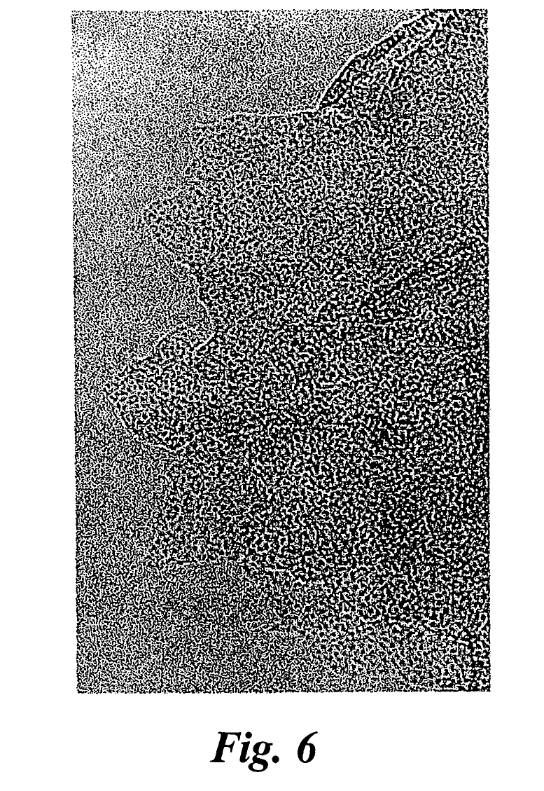

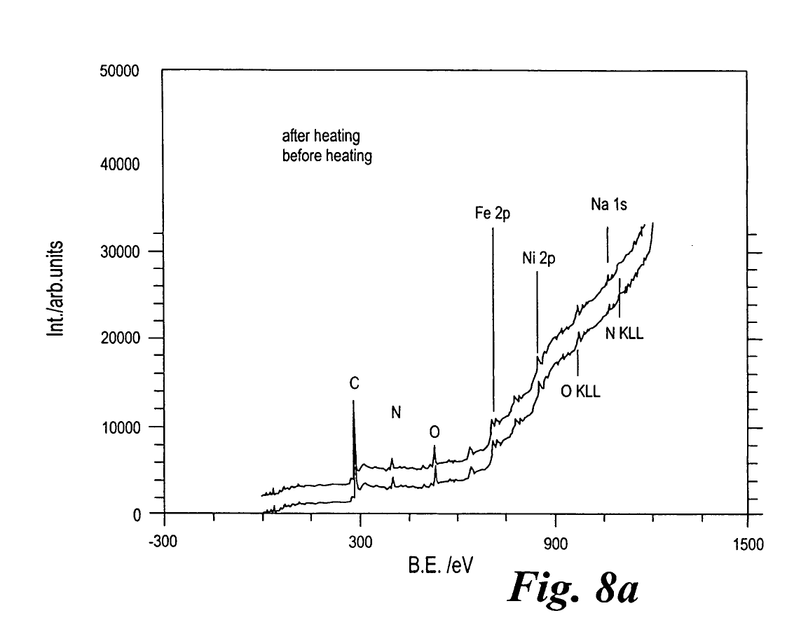

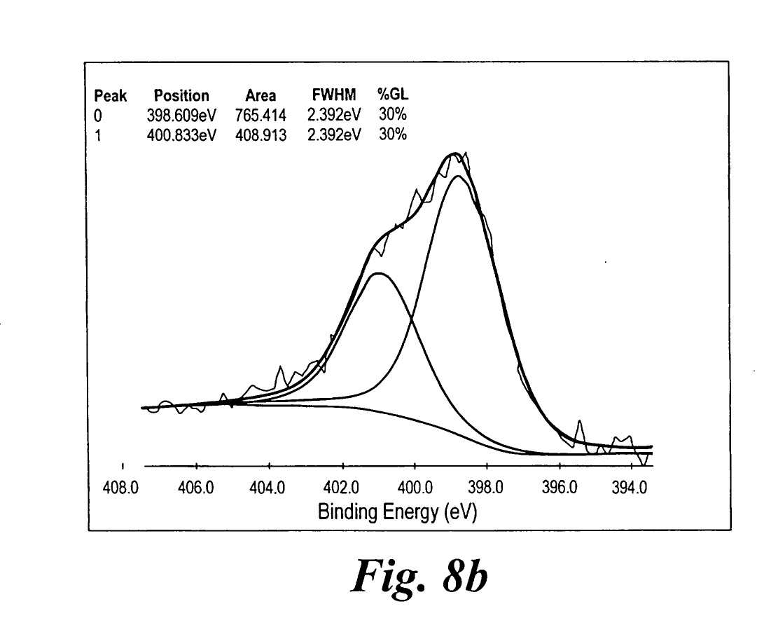

FIG. 6 shows a typical low-resolution TEM micrograph of the present precipitation sample. It is interesting to see many nanoscopic size particles with a very uniform particle size distribution. The particle contains Fe and Ni as confirmed by EDX analysis. Direct measurement on the micrograph shows that a majority of the encapsulated particle cores are in the size range of 10-15 nm. FIG. 8b shows the N region in an XPS spectrum.

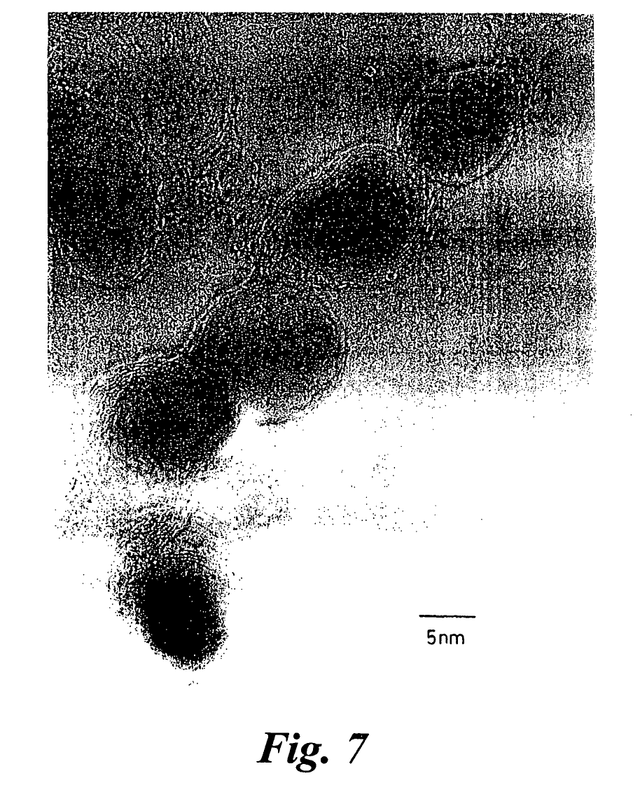

High resolution TEM micrographs (FIG. 7) indicate that all the particles after pyrolysis are found exclusively encapsulated in the quasi-spherical graphitic structures. These graphitic encapsulated particles are embedded in amorphous carbon material (the relative amount depends on the amount of polyvinyl alcohol used). Detailed examination of the quasi-spherical carbon coatings show that in many cases, carbon lattice fringes (ca. 3.4×10⁻¹⁰ m) could be traced, yielding surprisingly concentric carbon shelled structures. Only short exposure of the selected area to the electron beam is ensured (<60 s) to ensure that there is no possibility of carbon shelled structure formation being due to the electron beam illumination. Attempts to obtain a lattice image of the core particle were not successful on a Philips CM20 TEM microscope. It is believed that the fringe separations of the alloy particle (2.09×10⁻¹⁰ m, 1.79×10⁻¹⁰ m) are beyond the resolution of the microscope used (>2.4×10⁻¹⁰ m).

FIG. 8a shows XPS survey spectra of carbon-coated FeNi nanoparticles after encapsulation at 900° C. but before acid treatment to remove any non-fully encapsulated particles. An XPS survey was recorded on the sample without pre-treatment (before heating) and after it has been heated in situ at 250° C. for 30 minutes to desorb some possible contaminants. No major changes are observed in the resulting data. The spectra are very similar—upper line being before treatment and lower line after—showing the reproducibility of this measurement. All binding energies are given with an uncertainty of 0.2 eV on the absolute value. No charge effect being observed, the peaks are directly referenced to the carbon Cls peak at 284.6 eV.

It appears that the surface (or the first few atomic layers) contains essentially carbon but also with a small amount of other hetero-atoms (O, N, Na, Fe, Ni, etc). We detected small signals of Fe and Ni 2p and Auger peaks with the C:Fe and C:Ni atomic ratios being at around 0.05. This fact agrees with the TEM images in showing that the Fe/Ni are species totally encapsulated by carbon cages after heat treatment in N₂ at 900° C. because their signals are not strong. The binding energies of these exposed Fe and Ni species suggest that they are unlikely to be in metallic states. An oxygen signal is also found. It is not yet clear whether O is attached to the exposed iron/nickel species, or to nitrogen or carbon. Also, there are traces of sodium (Nals peak) in the calcined sample which probably came from the iron precursor used.

It is interesting to find that a nitrogen signal is observed. The surface contains nitrogen in an atomic ratio of 43:3 C to N. The Nls region (FIG. 8b) consists in a main peak at 398.6 eV with a shoulder at 400.8 eV. It has been reported that a Nls signal at 401 eV is characteristic of nitrogen atoms present in graphene sheets. It is thus concluded that a small amount of nitrogen is incorporated into the graphene network. It has also been reported that a strong peak at 398 eV with a shoulder at 400 eV was attributed to different C—N bonding (C═N and C—N). Hence it is believed that the carbon coating formed around the alloy particles during the heat treatment at 900° C. has a graphitic-like structure containing some nitrogen atoms. Nitrogen incorporation into graphene layer is responsible for the curvature of the graphitic planes resulting in encapsulation. The carbon coating of the nanoparticles prepared according to the precipitation method contains 7 surface atom % of nitrogen that may make these encapsulated particles fundamentally and structurally different from the ones produced by the Geus method whose carbon jacket contains only carbon atoms and hence is made up of essentially planar plates.

Magnetic Properties

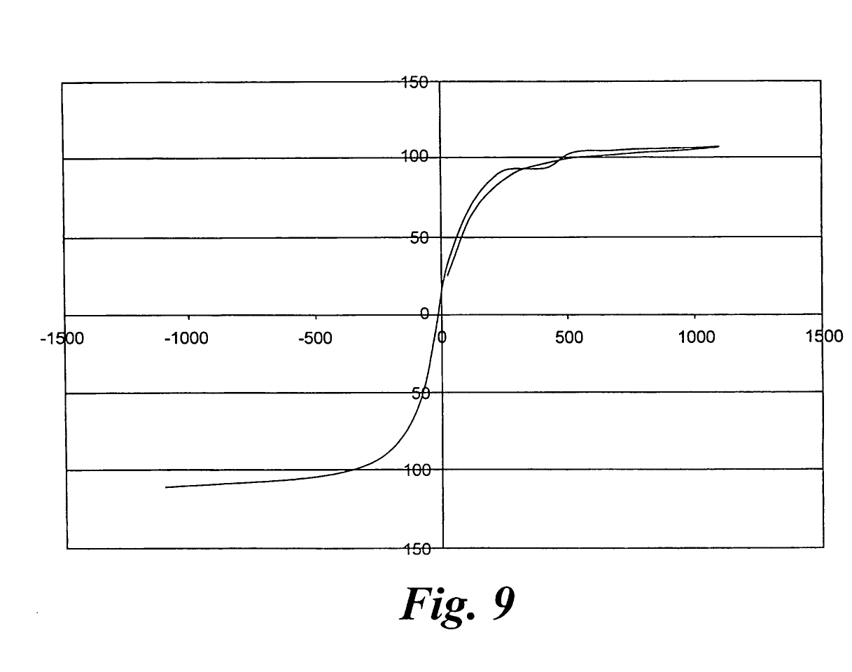

FIG. 9 shows the experimentally measured saturation magnetization of a typical spray-precipitation-pyrolysis sample. The material exhibits a saturation magnetization of 110 emu per gram mass of the sample at >8×10⁴ A/m (>1000 Oersted). We estimate from the TG experiments (not shown) that this typical carbon encapsulated nano-alloy sample contains 67% alloy content. Thus taking account of the alloy content which mainly contributes to the magnetization (the graphite jacket is thought to contribute insignificantly as compared to the central soft magnetic Fe—Ni alloy core), the saturation magnetization of this material per gram of alloy would be 165 emu/g. Literature value of bulk nickel-iron alloys of Ni:Fe ratio of 1.0 indicates 156 emu/g. Hence, within experimental error the present encapsulated alloy material appears to display a similar saturation magnetization to that of the bulk alloy. Table 1 summarises the comparison of the saturation magnetization values displayed by the spray-precipitation-pyrolysis sample with the literature values using the alumina-supported alloy particles with and without acid treatment.

TABLE 1
The normalised saturation magnetization values
per gram of Fe—Ni alloy in the two samples

| | After encapsulation | | | | |
|---|---|---|---|---|---|
| | Alloy | | | After HCl treatment | |
| | content | | Hc | | Hc |
| Sample | (wt %) | Ms(emu/g) | (Oe)* | Ms(emu/g) | (Oe) |
| Spray- | 67% | 165 | 1000 | 105 (8 hrs) | 1000 |
| precipitation- | | | | | |
| pyrolysis | | | | | |
| Alumina- | 18.8% | 130 | 100 | 48 (30 mins) | 50 |
| supported | | | | | |
| alloy | | | | | |

*1 Oe = 80 A/m

It is noted from the Table 1 that the slightly lower saturation magnetization of the Ni—Fe alloy on alumina (130 emu/g) of the Geus particles could be due to an incomplete reduction of metal oxides to alloy. Because of the much higher alloy content in the spray-precipitation-pyrolysis sample than Geus sample it displays a higher saturation magnetization value per gram of sample mass (110 vs 24.4). It is interesting to find that the saturation magnetization decreases when samples are treated with acid (36% decrease in the spray sample vs 63% in the alumina sample). It is believed that the decrease in saturation magnetization is caused by dissolution of alloy particles which have not been fully encapsulated by carbon layers. Hence, we believe that a larger quantity of fully encapsulated particles is made using the spray-precipitation pyrolysis technique whereby the impermeable graphitic layers offer a total protection to the encapsulated nanoparticles against leaching in the strong acidic environment. On the other hand, the Geus method does not provide a full protection of its encapsulated particles against acid treatment. Notice that the removal of alumina support would require acid treatment in order to release the carbon encapsulated Fe—Ni particles. It is however not entirely necessary for the spray samples where no support material is present. Even without acid treatment the present samples can equally disperse in aqueous medium very well as a colloid and without any significant attenuation in their saturation magnetization when the samples are pre-treated with a bleach solution (mild oxidation to introduce surface functionalities—such as phenolic and carboxylic groups on the carbon surface) at pH 9. These surface groups with different ε surface potentials provide anchoring points for catalyst (homogeneous or heterogeneous) immobilisation. At different pH, they also play a significant role for the particle dispersion or flocculation in the solvent.

Catalytic Action

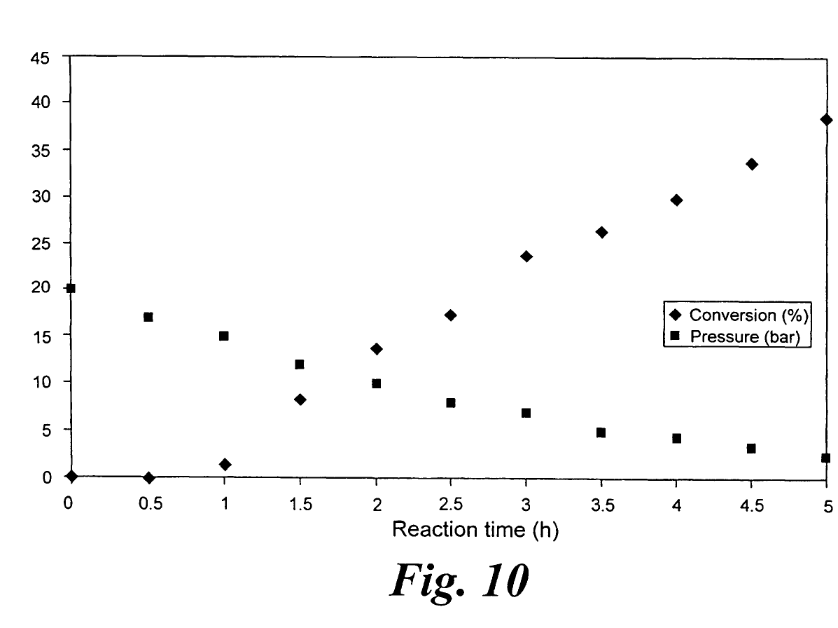

FIG. 10 shows the 5% Pd impregnated spray-precipitation-pyrolysis sample is an active catalyst for the hydrogenation of nitrobenzene to aniline. Table 2 shows the comparison of the initial rate of reaction (extrapolation to time zero) of this material with a commercial Pd/C catalyst.

TABLE 2
showing the initial rates of nitrobenzene
hydrogenation over two Pd samples

| | Initial rate (μ-mole of |
|---|---|
| | nitrobenzene converted to |
| Catalyst | aniline s⁻¹) |
| 5% Pd/spray-precipitation- | 1.529 (32 mg catalyst) |
| pyrolysis sample | |
| 5% Pd/C (a commercial catalyst) | 0.835 (50 mg catalyst) |

It is found that the present catalyst shows almost double the rate of hydrogenation compared to a commercial catalyst with the same metal loading. We attribute the higher activity of the Pd doped spray sample of the invention in nitrobenzene hydrogenation to the better Pd dispersion onto the nano-size carbon particles (colloidally dispersed in the solvent) as compared to the micro-size commercial catalyst powder. The flocculation of the nano-size magnetic catalyst particles is easily achieved by applying an external magnetic field, which facilitates its filtration from the product solution.

In general, premature clustering of ferromagnetic particles can be prevented by using soft ferromagnetic materials in which the remnant magnetic moment (the magnetic moment in the absence of a magnetic field) is low. The measured 110 emu per gram of the present (the saturation magnetization is greater than pure iron particles) allows effective precipitation (separation) or re-dispersion of the particles in liquid phase by simply switching the external magnetic field on or off. The magnetic interaction between magnetic particles can be modulated by the application of ‘spacer’ materials between the magnetic particles such as the number of carbon shells and the background amorphous carbon. By changing the relative concentration of the metal complexes and carbon sources (polymer+ligands) or changing the droplet size (using different spray heads) the overall magnetic properties of thee particles can be finely tuned.

### Synthesis Examples 8 to 20

The procedure of Synthesis Example 2 was followed, omitting the solution of polyvinyl alcohol, and with variations of the pyrolysis conditions as set out in Table 3 below. Table 3 also gives the particle size of the Fe—Ni alloy cores formed in the graphitic shells of the particles formed.

TABLE 3

| | | Flow | Temp | Max. | Time at | | Core |
|---|---|---|---|---|---|---|---|
| | | rate | rise | temp. | Max. | | particle |
| Example | Gas | (ml/min) | (o/min) | (° C.) | temp. (h) | | size (nm) |
| 8 | N₂ | 100 | 10 | 900 | 10 | | 44.7 |
| 9 | N₂ | 100 | 10 | 900 | 16.5 | | 35.8 |
| 10 | N₂ | 100 | 1 | 900 | 10 | | 29.0 |
| 11 | N₂ | 600 | 1 | 900 | 10 | | 27.7 |
| 12 | N₂ | 15 | 1 | 900 | 10 | | 26.4 |
| 13 | Ar | 100 | 10 | 900 | 10 | | 39.0 |
| 14 | Ar | 100 | 10 | 900 | 10 | | 37.5 |
| 15 | N₂ | 1000 | 10 | 900 | 10 | | 24.0 |
| 16 | Ar | 1000 | 1 | 900 | 10 | | 23.8 |
| 17 | Ar | 1000 | 10 | 600 | 10 | | 14.3 |
| 18 | Ar | 1000 | 1 | 600 | 10 | | 14.3 |
| 19 | Ar | 1000 | 1 | 900 | 6 | min. | 24.2 |
| 20 | Ar | 1000 | 20 | 900 | 6 | min. | — |

— not measured

It can be seen that a lower temperature increase rate, a lower maximum temperature and a higher gas flow rate contribute to smaller core size.

### Synthesis Examples 21 to 28

The procedure of Synthesis Example 2 was again followed, omitting the solution of polyvinyl alcohol, using different pairs of metal precursors, as shown in Table 4. The amounts of the precursors are chosen to aim at a metal/metal atomic ratio of 1:1 or 2:1. In Examples 21 to 25 ammonia solution was employed for precipitation as in Example 2, but in Examples 26 to 28 a very slightly alkaline solution (NaOH) was used instead. Table 4 also shows the atomic ratios of the elements in the precipitated particles before their pyrolysis and the size of the Fe—Ni alloy core after pyrolysis.

Table 4 shows that the use of a sulphur-containing ligand in Example 24 apparently inhibited the graphite shell formation, leading to a larger sintered core particle size. Analysis data indicated that in all Examples the complete decomposition of the cyanide groups, the metal reduction and alloy formation and carbon recrystallization all occurred below 600° C. XRD indicated that Fe—Ni alloy is formed and that Fe and Ni metals are absent (in accordance with the Fe/Ni phase diagram for the conditions employed).

TABLE 4

| | | | | | | | Core |
|---|---|---|---|---|---|---|---|
| | Metal cyanide | 2nd metal | Atomic ratios | | | | size |
| Example | precursor | precursor | Ni/Fe | C/Fe | C/Ni | N/C | (nm) |
| 21 | Na₂Fe(CN)₅NO.2H₂O | Ni(NO₃)₂.6H₂O | 1.92 | 5.15 | 2.68 | 1.35 | 23.8 |
| 22 | K₄Fe(CN)₆.3H₂O | Ni(NO₃)₂.6H₂O | 1.57 | 5.66 | 3.60 | 1.44 | 24.8 |
| 23 | (NH₄)₄Fe(CN)₆.xH₂O | Ni(NO₃)₂.6H₂O | 1.94 | 5.76 | 2.97 | 1.91 | 24.6 |
| 24 | Na₂Fe(CN)₅NO.2H₂O | Ni(SO₄).7H₂O | 1.98 | 4.77 | 2.41 | 1.38 | 58.3 |
| 25 | Na₂Fe(CN)₅NO.2H₂O | Ni(CH₃COO)₂.4H₂O | 1.84 | 4.97 | 2.70 | 1.35 | 22.2 |
| 26 | Na₂Fe(CN)₅NO.2H₂O | Ni(NO₃)₂.6H₂O | 1.00 | 4.92 | 4.94 | 1.22 | 22.0 |
| 27 | K₃Fe(CN)₆ | Ni(NO₃)₂.6H₂O | 0.97 | 5.08 | 5.25 | 1.31 | 18.5 |
| 28 | K₂Ni(CN)₄.xH₂O | FeCl₂.4H₂O | 0.97 | 3.66 | 3.73 | 0.95 | 43.5 |

### Synthesis Example 29

Here the procedure of Synthesis Example 2 (omitting the polyvinyl alcohol solution) was modified to enable formation of a Fe—Co alloy core. The maximum temperature was raised to 1000° C., to achieve alloy formation, in accordance with the Fe/Co phase diagram which indicate that 985° C. is the minimum temperature for formation of the Fe—Co phase. Slightly alkaline solution (NaOH) was used for precipitation. Data for this Example are:

| | |
|---|---|
| Metal cyanide precursor | Na₂Fe(CN)₅NO.2H₂O |
| Second metal precursor | Co(NO₃)₂.6H₂O |
| Atomic ratios of precipitated particles | |
| Co/Fe | 1.04 |
| C/Fe | 5.13 |
| C/Co | 4.93 |
| N/C | 1.22 |
| Core particle size | 49.1 nm |

### Synthesis Examples 30 to 32

Table 5 shows details of syntheses of carbon-encapsulated particles in which Fe and Zn are the metals. The procedure was in accordance with Synthesis Example 2 (omitting the polyvinyl alcohol solution) except that in Example 32 slightly alkaline NaOH was employed instead of ammonia solution. The calcining temperature was 900° C. for 10 hours as in Example 2. Analysis of the particles produced showed that the predominant phase in the core is Fe₃C, with some peaks in XRD corresponding to Zn(CN)₂ and some possible traces corresponding to Fe—Zn alloy. The core is ferromagnetic. This segregation to carbide, rather than alloy formation, presumably is thermodynamically favoured.

TABLE 5

| | | Zinc | Atomic ratios* | | | |
|---|---|---|---|---|---|---|
| Example | Iron precursor | precursor | Zn/Fe | C/Fe | C/Zn | N/C |
| 30 | Na₂Fe(CN)₅NO.2H₂O | Zn(NO₃)₂.6H₂O | 1.71 | 4.57 | 2.67 | 1.56 |
| 31 | Na₂Fe(CN)₅NO.2H₂O | Zn(NO₃)₂.6H₂O | 1.44 | 5.42 | 3.77 | 1.52 |
| 32 | Na₂Fe(CN)₅NO.2H₂O | Zn(NO₃)₂.6H₂O | 0.99 | 5.03 | 5.08 | 1.16 |

*analysis of precipitate before pyrolysis

### Synthesis Examples 33 to 35

Carbide formation in the core was also observed when Fe and Mn were the metals. Details are given in Table 6.

TABLE 6

| | | Manganese | Atomic ratios* | | | | Size |
|---|---|---|---|---|---|---|---|
| Example | Iron precursor | precursor | Mn/Fe | C/Fe | C/Mn | N/C | (nm) |
| 33 | Na₂Fe(CN)₅NO.2H₂O | Mn(NO₃)₂.4H₂O | 2.66 | 5.00 | 1.90 | 1.45 | 93.6 |
| 34 | Na₂Fe(CN)₅NO.2H₂O | Mn(NO₃)₂.4H₂O | 2.42 | 6.70 | 2.76 | 1.47 | — |
| 35 | Na₂Fe(CN)₅NO.2H₂O | Mn(NO₃)₂.4H₂O | 1.03 | 4.97 | 4.81 | 1.16 | — |

— = not measured.
*analysis of precipitate before pyrolysis

The procedure was as in Example 2, omitting the polyvinyl alcohol solution. In Example 35, the NaOH solution was used for precipitation.

In analysis, EDX showed a good signal of the Fe and Mn after the sample was calcined. Excellent carbon encapsulation of cores containing Fe and Mn within graphitic shells were shown by the TEM micrographs. XRD on the other hand, indicated that the predominant phases were Mn₅C₂ and FeC₃ (or Fe₇C₃) with some minor phases which appeared to match with FeMn₄ (alloy). It is noted that a phase diagram of Fe and Mn suggests that they should form alloy under the conditions. However, in the presence of carbon atoms, phase segregation to their carbides was clearly evident under the reaction temperatures. The particles are ferromagnetic.

### Synthesis Examples 36-39

Using Na₂Fe(CN)₅NO.2H₂O as the iron precursor, the procedure of Example 2 (omitting polyvinyl alcohol solution) was performed using Ca salts as a second metal precursor (alone or in combination with Ni). Compare Example 4 above. The materials, ICP (Inductive Couple Plasma) data, calcining gas and XRP results are shown in Table 7.

TABLE 7

| | | ICP (wt %) | | | Cal. | XRD | |
|---|---|---|---|---|---|---|---|
| Example | 2nd metal precursor | Fe | Ni | Ca | gas | Phase | Size (nm) |
| 36 | Ca(NO₃)₂.4H₂O | 16.60 | 0.00 | — | N₂ | Ca(CN)₂ + Fe₃C + Fe | 33.9 |
| 37 | CaCl₂ | 14.40 | 0.00 | 17.00 | N₂ | Ca(CN)₂ + Fe + Fe₃C | — |
| 38 | CaSO₄ | 5.79 | 0.00 | 21.40 | N₂ | CaS + Ca₂Fe₂O₅ + CaO | — |
| 39 | Ni(NO₃)₂.6H₂O/Ca(NO₃)₂.4H₂O | 13.00 | 12.60 | — | Ar | FeNi + Ca(CN)₂ | 25.8 |

— = not measured

As discussed in Example 4, no known alloy phase of Fe—Ca is previously reported. In this particular case, characterisations (XRD, TEM, FTIR, EDX) were carried out after calcination (before and after acid treatment). Before the acid treatment it was interesting to find that the dominant phases were FeC₃ (25-33 nm), Fe and Ca(CN)₂ (EDX showed a high concentration of Ca and FTIR indicated the CN structure). After the acid treatment the Ca content and Ca(CN)₂ phase were significantly attenuated but the Fe carbide and Fe phases remained unchanged. This clearly suggests that some Ca phases were apparently not protected by the graphitic shells. Presumably the carbon encapsulation was only initiated by the iron since no alloy was present.

### Synthetic Examples 40 to 44

Carbon-coated Fe—Cu particles were obtained. Precursor materials and results are given in Table 8. The procedure of Example 2 (omitting polyvinyl alcohol solution) was followed, except that the NaOH solution was employed in Examples 43 and 44. The two core sizes relate to the Fe and Cu phases respectively.

TABLE 8

| | | Copper | Atomic ratios* | | | | Size |
|---|---|---|---|---|---|---|---|
| Example | Iron precursor | precursor | Cu/Fe | C/Fe | C/Cu | N/C | (nm) |
| 40 | Na₂Fe(CN)₅NO.2H₂O | Cu(NO₃)₂.3H₂O | 1.02 | 3.68 | 3.62 | 1.32 | — |
| 41 | Na₂Fe(CN)₅NO.2H₂O | CuSO₄.5H₂O | 3.34 | 4.36 | 1.31 | 3.01 | — |
| 42 | Na₂Fe(CN)₅NO.2H₂O | Cu(CH₃COO)₂ | — | — | — | — | 33.7/80.4 |
| 43 | Na₂Fe(CN)₅NO.2H₂O | Cu(NO₃)₂.3H₂O | 1.04 | 5.01 | 4.78 | 1.24 | 46.8/88.0 |
| 44 | Na₂Fe(CN)₅NO.2H₂O | CuSO₄.5H₂O | 1.00 | 4.04 | 4.03 | 1.14 | — |

*analysis of precipitate before pyrolysis
— = not measured

According to the chemical analyses Fe—Cu (1:1) species can be selectively precipitated by using ammonia or NaOH. The TEM produced a clear evidence of particle encapsulation within graphitic shells. On the other hand, XRD indicated separated Fe and Cu phases (33.7 nm Fe, 80.4 nm Cu), despite the fact that formation of Fe—Cu alloy was predicted (no carbide phases were derived).

### Synthetic Examples 45 and 46

Table 9 gives data for two further examples where ferromagnetic alloy cores not containing Fe were encapsulated in graphitic shells, using the method of Example 2 (omitting polyvinyl alcohol solution).

TABLE 9

| | Metal cyanide | 2nd metal | Molar ratios | | | | XRD | |
|---|---|---|---|---|---|---|---|---|
| Example | precursor (1) | precursor (2) | (2)/(1) | C/(1) | C/(2) | N/C | phase | size |
| 45 | K₂Ni(CN)₄.xH₂O | Co(NO₃)₂.6H₂O | 1.1 | 2.7 | 2.5 | 1.5 | NiCo | 120.6 |
| 46 | K₂Pt(CN)₄.3H₂O | Co(NO₃)₂.6H₂O | 1.0 | 3.7 | 3.7 | 1.1 | CoPt | 21.0 |

* analysis of precipitate before pyrolysis

### Example 47

### Magnetic Property

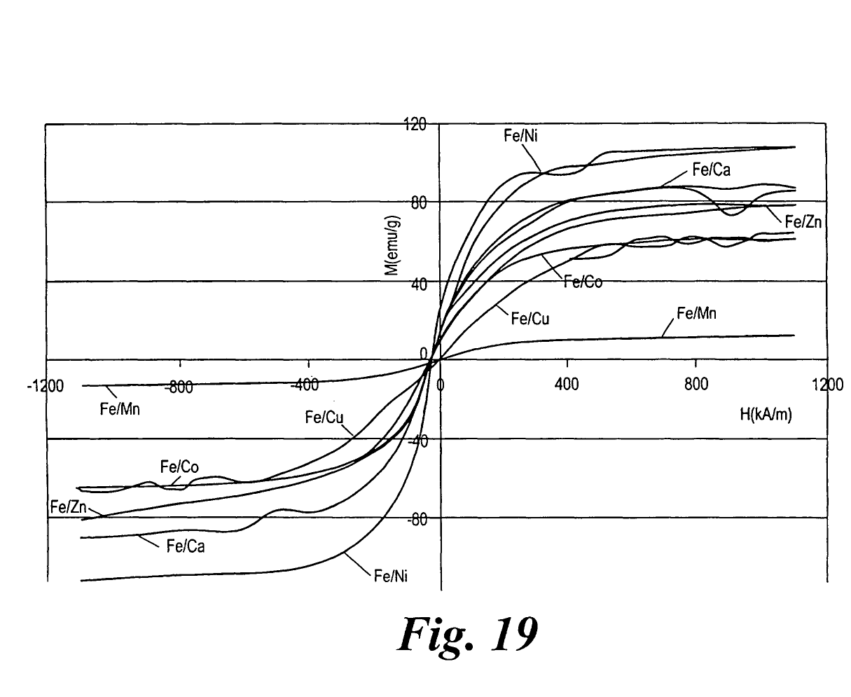

FIG. 9 discussed above shows magnetization properties of one example of particles of the present invention. FIG. 19 shows the magnetic responses, obtained in the same manner, for other graphite encapsulated magnetic particles (containing metal, alloy, carbide or mixtures) obtained as described above. The components are Fe—Ni (as in FIG. 9), Fe/Ca (probably Fe₃C phase), Fe—Cu, Fe/Mn (carbides), Fe/Zn (carbides), Fe—Co.

It is shown that these carbon protected magnetic particles all displayed no magnetic hysteresis (a high magnetisation response but with no magnetic aggregation of the fine particles in solution in the absence of non-homogenous magnetic field). Hence they are well suited as magnetic catalyst particles. It has been demonstrated that these fine particles can be magnetically precipitated under non-uniform magnetic field and be re-dispersed in the absence of magnetic field (with stir).

### Example 48

### Catalysis

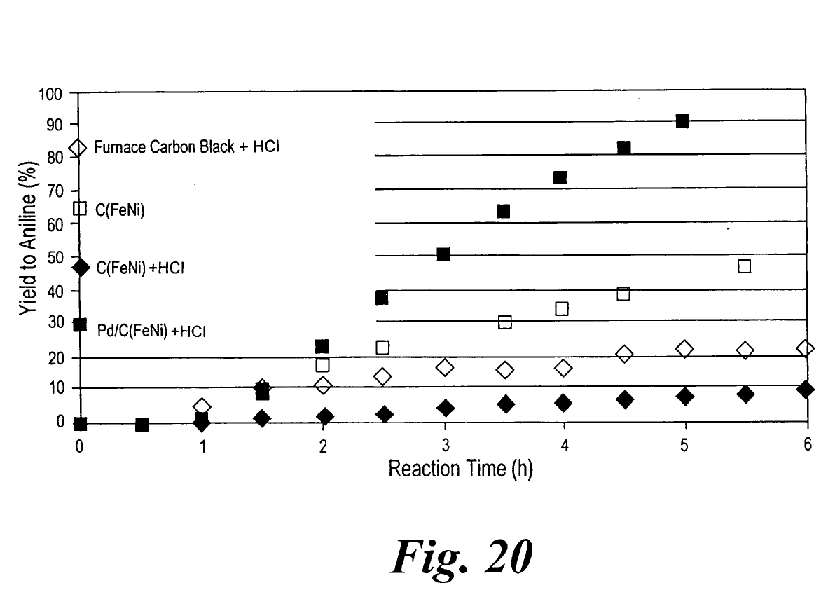

Additional catalytic results are given in FIG. 20, for

| | |
|---|---|
| furnace carbon black treated with HCl | (⋄) |
| particles of Example 2, before acid treatment | (□) |
| particles of Example 2 treated with HCl | (♦) |
| particles of Example 2 treated with HCl | (▪) |
| and carrying Pd | |

Hydrogenation of nitrobenzene 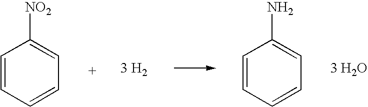
300 ml batch stainless steel Parr reactor:
Substrate: nitrobenzene (6.5 ml)
Solvent: isopropanol (IPA, 125.0 ml)
Catalyst 12 mg.
Purges: flowing N₂ (ambient pressure/15 minutes)+pure H₂ (20 bar/3 times).
Stirring (560 rpm), pressure (H₂, 40 bar), temperature (80° C.), time (6 h).

The particles having noble metal (Pd) at the surface rapidly catalyse hydrogenation of nitrobenzene at a much faster rate than the reaction catalysed by the acid sites on carbon surface. In our study, HCl treatment was used to remove the unprotected metal or alloy from the carbon coated Fe—Ni sample. From the figure the activity for the HCl treated carbon encapsulated magnetic Fe—Ni phase was shown to be comparable to the HCl-treated furnace carbon black (a low activity). It was shown clearly the Pd deposited onto these magnetic carbon composites can be used as an excellent Pd supported catalyst for the reaction. It was clearly demonstrated that these fine composite catalyst particles can be magnetically precipitated when the non-uniform magnetic field was applied.

1. A method of forming microparticles with a ferromagnetic core encapsulated in a graphitic shell containing hetero atoms, which includes the steps of providing a solution containing source material of a ferromagnetic metal, carbon and the hetero atoms, forming solidified particles containing source material of the ferromagnetic metal, carbon and the hetero atoms from said solution, and pyrolysing said solidified particles in inert gas so as to form said ferromagnetic core and said encapsulating graphitic coating containing hetero atoms.

2. A method according to claim 1, wherein the solution is divided into droplets prior to forming of the solidified particles.

3. A method according to claim 2, wherein the solidification is carried out by precipitation of the droplets.

4. A method according to claim 2, wherein the solidification is carried out by injection of the droplets into the pyrolysis zone.

5. A method according to claim 1, wherein the solidified particles are formed by chemical precipitation in bulk in said solution.

6. A method according to claim 1, wherein the hetero atoms are at least one of N, B, P or O.

7. A method according to claim 1 wherein the solution contains at least one of a metal cyanide compound, a metal isocyanide compound, a metal cyanate compound and a metal isocyanate.

8. A method according to claim 7 wherein said compound contains a complex anion selected from metal cyanide, metal isocyanide, metal cyanate and metal isocyanate complex anions.

9. A method according to claim 1 wherein the solution contains a cationic species containing or consisting of a first metal and an anionic species containing a second metal, the first and second metal being the same or different and at least one of the first and second metals being ferromagnetic.

10. A method according to claim 9 wherein each of the first and second metal are selected from Fe, Ni, Ca, Zn, Cu, Mn, Co, Mg, Pd, Pt, Ti, Mo and V.

11. A method according to claim 1 wherein the ferromagnetic core contains at least one metal in elemental or alloy form.

12. A method according to claim 1 wherein the ferromagnetic core contains at least one metal carbide.

13. A method according to claim 1, wherein the solution additionally contains a diluent precursor which form a diluent for the pyrolysed particles.

14. A method according to claim 13, wherein the diluent precursor is a decomposable carbon-containing compound which forms an amorphous matrix upon pyrolysis.

15. A method according to claim 1 including the step of treating the surface of the particles and/or the matrix to produce catalytic activity.

16. A method according to claim 15, wherein the treatment includes deposition of a catalytically active metal.

17. Microparticles having a ferromagnetic core encapsulated by a graphitic curved shell containing hetero atoms.

18. Microparticles according to claim 17, wherein the curved shell is of a plurality of layers of graphite sheets.

19. Microparticles according to claim 17 or claim 18 wherein the core has a diameter in the range 5 to 500 nm, preferably 10 to 150 nm.

20. Microparticles according to claim 17 or claim 18 which are embedded in an amorphous matrix.

21. Microparticles according to claim 17 which have a catalytically-active surface.

22. Microparticles according to claim 20, wherein the matrix has a catalytically-active surface.

23. Microparticles according to claim 21 or 22, wherein the catalytic activity is due to a metal deposited on the surface.

24. Microparticles according to claim 17 wherein the ferromagnetic core consists of at least one phase selected from metal, alloy, carbide and oxide.

25. Method which comprises utilizing microparticles according to claim 17 as catalyst in a liquid-phase reaction.

26. Method which comprises utilizing microparticles made by the method of claim 1 as catalyst in a liquid phase reaction.
